(19) United States
(12) Patent Application Publication
(10) Pub. No.: US 2025/0383491 A1
(43) Pub. Date: Dec. 18, 2025

(54) POLARIZING ELEMENT

(71) Applicant: AGC Inc., Tokyo (JP)

(72) Inventors: Atsushi TAKAHASHI, Fukushima (JP); Koichi TASHIMA, Fukushima (JP); Naoto TATSUOKA, Tokyo (JP)

(73) Assignee: AGC Inc., Tokyo (JP)

(21) Appl. No.: 19/303,619

(22) Filed: Aug. 19, 2025

Related U.S. Application Data
(63) Continuation of application No. PCT/JP2024/004355, filed on Feb. 8, 2024.

(30) Foreign Application Priority Data
Feb. 24, 2023 (JP) 2023-027569

(51) Int. Cl. G02B 5/30; C08F 20/10; C09K 19/38

(52) U.S. Cl. CPC G02B 5/3016; C08F 20/10; C09K 19/3852

(57) ABSTRACT

A polarizing element including: a first planar member transparent to light; liquid-crystal polymer members provided on a surface of the first planar member so as to extend in one direction at a regular interval having a predetermined pitch along the surface of the first planar member; and an isotropic member provided on the surface of the first planar member so as to contain the liquid-crystal polymer members, in which an aspect ratio is smaller than 1, the aspect ratio being a ratio of a height of each of the liquid-crystal polymer members to 1/2 times the pitch between two of the liquid-crystal polymer members adjacent to each other.

### CROSS-REFERENCE TO RELATED APPLICATIONS

This is a continuation of International Application No. PCT/JP2024/004355 filed on Feb. 8, 2024, and claims priority from Japanese Patent Application No. 2023-027569 filed on Feb. 24, 2023, the entire contents of which are incorporated herein by reference.

### TECHNICAL FIELD

The present invention relates to a polarizing element.

### BACKGROUND ART

A device called a waveplate is used in the related art to control polarization of light emitted from a light source. In the field of optical communication technique for transmitting large volumes of signals, called wavelength division multiplexing, an optical switch such as a wavelength selective switch (WSS) needs to operate a plurality of optical signals arranged in parallel. The wavelength selective switch requires a waveplate to control polarization of a plurality of optical signals arranged in parallel.

Patent Literature 1 discloses a waveplate obtained by alternately stacking a birefringence zone in which polarization of incident light is rotated and a non-birefringence zone in which polarization of incident light is not rotated.

Patent Literature 1: U.S. Pat. No. 10,436,947B2

### SUMMARY OF INVENTION

However, the waveplate in Patent Literature 1 has a problem that fine irregularities are required to be processed.

The present invention has been made in view of the above circumstances, and an object of the present invention is to provide a polarizing element that does not require processing of fine irregularities.

The present invention provides a polarizing element including: a first planar member transparent to light; liquid-crystal polymer members provided on a surface of the first planar member so as to extend in one direction at an regular interval having a predetermined pitch along the surface of the first planar member; and an isotropic member provided on the surface of the first planar member so as to contain the liquid-crystal polymer members, in which an aspect ratio, which is a ratio of a height of each of the liquid-crystal polymer members to ½ times the pitch between two of the liquid-crystal polymer members adjacent to each other, is smaller than 1.

According to the present invention, it is possible to provide a polarizing element that does not require processing of fine irregularities.

### BRIEF DESCRIPTION OF DRAWINGS

FIG. 1 is a diagram schematically illustrating an example of a polarizing element according to one embodiment.

FIG. 2 is a cross-sectional view of the polarizing element taken along a line A-A.

FIG. 3 is a diagram illustrating an example of a first polarizing element for comparison.

FIG. 4 is a diagram illustrating an example of a second polarizing element for comparison.

FIG. 5 is a diagram showing a transmittance, a phase step, and an aspect ratio of polarizing elements in Examples 1 to 3.

### DESCRIPTION OF EMBODIMENTS

Hereinafter, with reference to the drawings as appropriate, detailed description is given of embodiments specifically disclosing a polarizing element according to the present invention. However, unnecessary detailed description may be omitted. For example, detailed description of well-known matters and redundant description of substantially same configurations may be omitted. This is to avoid making the following description unnecessarily redundant and to facilitate understanding by those skilled in the art. Note that, the accompanying drawings and the following description are provided for those skilled in the art to fully understand the present invention, and are not intended to limit the subject matter described in the claims.

In the present description, a transmittance of, for example, 90% or more in a specific wavelength region means that the transmittance does not fall below 90% in the entire specific wavelength region, that is, a minimum transmittance is 90% or more in the wavelength region. Note that, unless otherwise specified, a refractive index refers to a refractive index for light having a wavelength of 1550 nm at 25° C.

The transmittance can be calculated based on a ratio of an intensity of incident light and an intensity of transmitted light. In the present description, “to” representing a numerical range includes upper and lower limits.

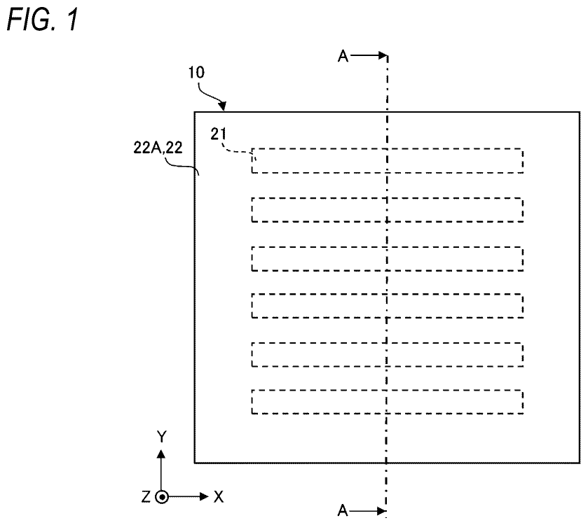

A front view schematically illustrating an example of a polarizing element 10 according to one embodiment is described with reference to FIG. 1. FIG. 1 is a diagram schematically illustrating an example of the polarizing element 10 according to one embodiment. A configuration example of the polarizing element 10 according to one embodiment of the present invention is described with reference to the drawings.

The polarizing element 10 according to one embodiment of the present invention is a transmissive polarizing element. The shape of the polarizing element 10 is, for example, a flat plate shape. The shape of a surface of the polarizing element 10 may be any shape such as a quadrangle, a circle, or an ellipse. The surface of the polarizing element 10 is a surface on which light is incident or transmitted. Hereinafter, an example in which the shape of the surface of the polarizing element 10 according to one embodiment is a quadrangle is described. However, the polarizing element according to the present invention is not limited to such an example, and can have any shape according to the application, function, and the like thereof.

The polarizing element 10 according to one embodiment of the present invention is used, for example, as a polarization rotation element that rotates polarization of incident light. For example, the polarizing element 10 rotates a polarization direction of the incident light by 90°. The polarization of the incident light is, for example, S polarization or P polarization.

Note that, the angle at which the polarizing element 10 rotates the polarization is not limited to 90°, and can be set to any angle according to the application.

The polarizing element 10 according to one embodiment of the present invention is used, for example, for a wavelength selective switch. In the wavelength selective switch, an optical switch is performed using, for example, a liquid crystal on silicon (LCOS), but since the LCOS has strong polarization dependency, it is necessary to align the polarization of light enters the LCOS.

The polarizing element 10 is, for example, an element having a size of several millimeters to several tens of centimeters square. Note that, the size of the polarizing element 10 can be changed according to the application. The surface of the polarizing element 10 is covered with a transparent antireflection film 22.

In the present description, “transparent” means that the transmittance with respect to light having a wavelength λ belonging to a use band is high, and for example, means that the transmittance with respect to the light is 70% or more. The wavelength λ in the use band of the polarizing element 10 according to one embodiment is preferably, for example, 1525 nm to 1630 nm. Hereinafter, the band of 1525 nm to 1630 nm is referred to as the present use band.

The antireflection film 22 is a thin film for preventing the incident light on the polarizing element 10 from being reflected. That is, the antireflection film 22 prevents a reflection loss of the incident light. The antireflection film 22 prevents reflection of light having a wavelength of 1525 nm to 1630 nm, which is the use band of the polarizing element 10. As the antireflection film 22, for example, a single-layer film made of a material having a refractive index lower than that of a glass substrate can be applied. In addition, since the antireflection film 22 has a configuration in which a high refractive index film and a low refractive index film are alternately stacked, it is possible to realize lower reflectivity. The high refractive index film here means a film having a refractive index of 1.9 or more at a wavelength of 1550 nm, and the low refractive index film means a film having a refractive index of 1.6 or less at a wavelength of 1550 nm. Examples of a material for the high refractive index film include titanium oxide, niobium oxide, and tantalum oxide, and examples of a material for the low refractive index film include silicon oxide, aluminum oxide, and magnesium oxide.

The polarizing element 10 includes a plurality of liquid-crystal polymer members 21 therein. The liquid-crystal polymer members 21 shown in FIG. 1 each have a rectangular parallelepiped shape. Note that, for convenience of description, an axis extending in a longitudinal direction of each of the liquid-crystal polymer members 21 on a side of the polarizing element 10 as shown in FIG. 1 is defined as an X axis. An axis perpendicular to the X axis and parallel to a direction in which the liquid-crystal polymer members 21 are arranged is defined as a Y axis. An axis perpendicular to the X axis and the Y axis is defined as a Z axis. The expressions related to these directions are used for convenience of description, and are not intended to limit the posture of the structure during actual use. The same applies to other drawings.

Each of the liquid-crystal polymer members 21 is disposed such that the longitudinal direction thereof is parallel to the X axis. In addition, the liquid-crystal polymer members 21 are arranged at a predetermined interval in the Y-axis direction. The shape of each of the liquid-crystal polymer members 21 shown in FIG. 1 is a rectangular parallelepiped long in the X-axis direction, but is not limited to the rectangular parallelepiped, and may be any shape having a predetermined thickness in the Z-axis direction. The number of the liquid-crystal polymer members 21 shown in FIG. 1 is six, but is not limited to six and may be any number depending on the application.

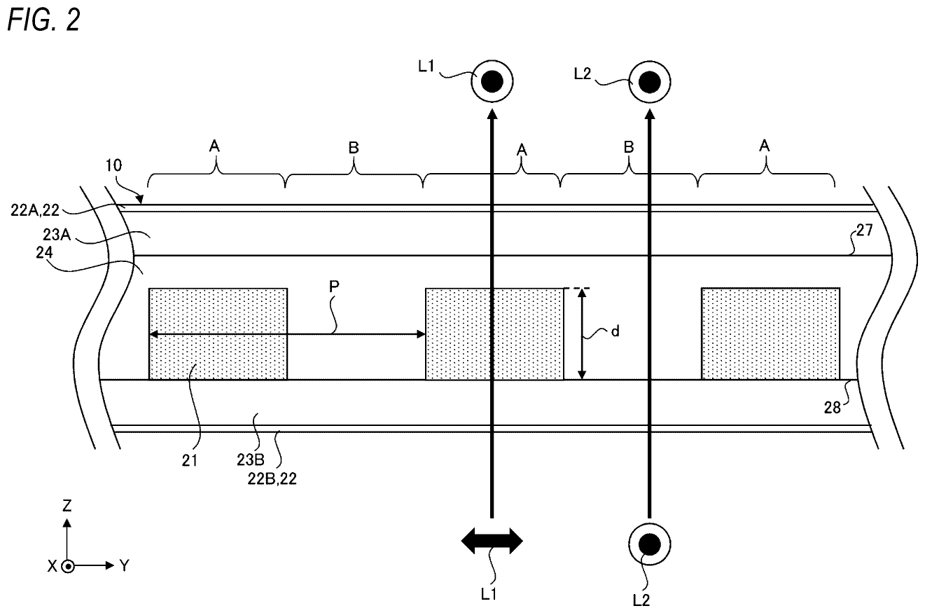

Next, a cross-sectional view of the polarizing element 10 taken along a line A-A is described with reference to FIG. 2. FIG. 2 is the cross-sectional view of the polarizing element 10 taken along the line A-A.

FIG. 2 illustrate a cross section of the polarizing element 10 taken along the line A-A shown in FIG. 1. The polarizing element 10 includes the liquid-crystal polymer members 21, antireflection films 22A and 22B, deterioration preventing materials 23A and 23B, and an isotropic material 24.

The antireflection films 22A and 22B are thin films provided on a surface which light enters and a surface through which light is transmitted in the polarizing element 10. In the example illustrated in FIG. 2, the antireflection film 22A is formed on an outer surface of the deterioration preventing material 23A. Note that, the antireflection film 22A may be referred to as a second antireflection film. The antireflection film 22B is formed on an outer surface of the deterioration preventing material 23B. Note that, the antireflection film 22B may be referred to as a first antireflection film. The antireflection films 22A and 22B are formed by a vacuum deposition method, a sputtering method, or the like. The antireflection films 22A and 22B each have a thickness of, for example, about 0.5 μm. Note that, the thickness of the antireflection films 22A and 22B is not limited to 0.5 μm. The antireflection film 22 is made of an isotropic material. The antireflection films 22A and 22B may be provided on one of the surface which light enters and the surface through which light is transmitted in the polarizing element 10, or may be omitted from the polarizing element 10, but are preferably provided on both surfaces for the reason of a high transmittance with respect to target light.

The deterioration preventing materials 23A and 23B are formed of, for example, a transparent isotropic material such as quartz. The deterioration preventing materials 23A and 23B are used to ensure durability against a high-temperature or high-humidity environment. The deterioration preventing material 23A is provided in contact with a first surface 27 of the isotropic material 24. The first surface 27 is a surface of the isotropic material 24 and the surface is closer to the surface through which light is transmitted in the polarizing element 10. Note that, the deterioration preventing material 23A may be referred to as a second planar member. The deterioration preventing material 23B is provided in contact with a second surface 28 including the liquid-crystal members 21 and the isotropic material 24. The second surface 28 is a surface of the liquid-crystal members 21 and the isotropic material 24 and the surface is closer to the surface which light enters in the polarizing element 10. Note that, the deterioration preventing material 23B may be referred to as a first planar member. The deterioration preventing materials 23A and 23B are formed, for example, by applying a resist to a liquid-crystal polymer constituting the liquid-crystal polymer members 21, followed by sintering and ultraviolet irradiation. The deterioration preventing materials 23A and 23B preferably each have a thickness about several hundred μm to several mm from the viewpoint of productivity. Note that, the thicknesses of the deterioration preventing materials 23A and 23B may be appropriately set according to the productivity, the application, or the like.

The liquid-crystal polymer members 21 are formed by, for example, forming a film on a substrate and then using a photolithography method, a dry etching method, or a double spin method. The substrate is, for example, the deterioration preventing material 23.

The liquid-crystal polymer constituting the liquid-crystal polymer members 21 has optical anisotropy, and causes birefringence of incident light. The liquid-crystal polymer constituting the liquid-crystal polymer members 21 has two different refractive indices in the polarization direction with respect to an optical axis of the incident light. For the liquid-crystal polymer constituting the liquid-crystal polymer members 21, the refractive index with respect to a slow axis is defined as ne, and the refractive index with respect to a fast axis is defined as nₒ. For example, the nₒ is 1.5258 and the nₑ is 1.6251 at 1525 nm. The polarization direction of the light transmitted through each of the liquid-crystal polymer members 21 is rotated based on a difference Δn between the nₑ and the nₒ. Each of the liquid-crystal polymer members 21 functions as a (½)λ plate by which the polarization direction of the transmitted light is rotated by 90°. For the liquid-crystal polymer members 21, angles of the slow axis and the fast axis with respect to the optical axis of the incident light and a height d are set such that the polarization direction of the transmitted light is rotated by 90°. The liquid-crystal polymer constituting the liquid-crystal polymer members 21 is an optically anisotropic material having a value of Δn at 1550 nm of 0.03 to 0.12, which is preferably 0.05 to 0.11 since a phase step can be further reduced. The height d of each of the liquid-crystal polymer members 21 is 2 μm to 10 μm according to the value of Δn.

The liquid-crystal polymer members 21 are arranged at an equal interval having a predetermined pitch P on the surface of the deterioration preventing material 23B. Note that, the pitch P is a formation interval between two of the liquid-crystal polymer members 21 adjacent to each other arranged in the Y direction of the polarizing element 10. The pitch P is preferably 100 μm to 1000 μm from the viewpoint of preventing productivity deterioration due to fine processing.

An aspect ratio of each of the liquid-crystal polymer members 21 is obtained by dividing the height d by a value that is obtained by dividing the pitch P by 2. For example, in the case where the height d of each of the liquid-crystal polymer members 21 is 8.9 μm and the pitch P is 400 μm, the aspect ratio is 0.0445. As the aspect ratio increases, the height d increases and the pitch P decreases. That is, as the aspect ratio increases, each of the liquid-crystal polymer members 21 is elongated in the Z-axis direction, and a portion where the liquid-crystal polymer members 21 exist in the polarizing element 10 has a fine structure. On the other hand, as the aspect ratio decreases, the height d decreases and the pitch P increases. That is, as the aspect ratio decreases, each of the liquid-crystal polymer members 21 is longer in the Y-axis direction, and the portion where the liquid-crystal polymer members 21 exist in the polarizing element 10 has a structure that does not require fine processing. The aspect ratio is 0.01 to 0.2 according to the possible ranges of the values of the height d and the pitch P.

The liquid-crystal polymer members 21 are made of a liquid-crystal polymer having a high transmittance in the present use band. The high transmittance indicates, for example, that the transmittance with respect to light having a wavelength in the present use band is 90% or more. The liquid-crystal polymer constituting the liquid-crystal polymer members 21 may be, for example, a composite liquid-crystal polymer in which a crosslinking agent for ensuring the durability under a high-temperature and/or high-humidity environment is added. By using the composite liquid-crystal polymer in which the crosslinking agent is added as the liquid-crystal polymer constituting the liquid-crystal polymer members 21, it is possible to prevent deterioration of the liquid-crystal polymer members 21 during the production process or in the environment in which the polarizing element 10 is used, and to provide the polarizing element 10 having high reliability. Here, the high reliability indicates that the polarization rotates with high accuracy and the polarizing element has a high transmittance.

The liquid-crystal polymer constituting the liquid-crystal polymer members 21 is obtained, for example, by polymerizing a liquid-crystal composition containing a polymerizable liquid crystal. Here, a content of the polymerizable liquid crystal in the liquid-crystal composition is, for example, 75 mass % or more. The polymerizable liquid crystal is a compound having both polymerizability and liquid crystallinity, and is, for example, a compound having a structure (also referred to as a mesogenic group or a mesogenic skeleton) that exhibits a liquid-crystal function. The liquid-crystal polymer constituting the liquid-crystal polymer members 21 is preferably a compound represented by the following formula (1) (see JP4998269B2), and the structure that exhibits a liquid-crystal function in the compound represented by the formula (1) is a structure in which four ring groups E1 to E4 described below are directly bonded.

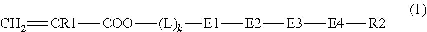

The symbols in the formula represent the following.

R1 is a hydrogen atom or a methyl group.

R2 is an alkyl group having 1 to 8 carbon atoms or a fluorine atom.

k is 0 or 1.

L is —(CH₂)ₚO— or —(CH₂)_{q}—, provided that p and q are each independently an integer of 2 to 8.

E1 is a 1,4-phenylene group.

E2, E3, and E4 are each independently a 1,4-phenylene group or a trans-1,4-cyclohexylene group, and at least one of E2 or E3 is a trans-1,4-cyclohexylene group.

In the 1,4-phenylene group and the trans-1,4-cyclohexylene group in E1 to E4, a hydrogen atom bonded to a carbon atom in the group may be substituted with a fluorine atom, a chlorine atom, or a methyl group.

The isotropic material 24 is provided by filling spaces between the liquid-crystal

polymer members 21 arranged at an equal interval. The isotropic material 24 is a transparent isotropic material. Examples of the isotropic material 24 include an ultraviolet curable adhesive, a multifunctional reactive adhesive, and a thermosetting adhesive. A thickness of the isotropic material 24 is preferably a thickness (for example, 20 μm) equal to or greater than the height d of each of the liquid-crystal polymer members 21 from the viewpoint of the productivity. Note that, the isotropic material 24 may be referred to as an isotropic member.

A refractive index of the isotropic material 24 is preferably 1.45 to 1.73 at 1550 nm in order to reduce a phase step, which is a difference in optical distance between light transmitted through each of the liquid-crystal polymer members 21 and light transmitted through the isotropic material 24. Here, the phase step can be obtained by an equation of |n−(nₑ+nₒ)/2|×d, where n is the refractive index of the isotropic material 24. The optical distance is a value obtained by multiplying a refractive index of a medium through which light travels by the distance which light travels. When the phase step is large, the light transmitted through each of the liquid-crystal polymer members 21 and the light transmitted through the isotropic material 24 may have different coupling efficiencies to a fiber, which may result in a decrease in signal level. The phase step between the each of the liquid-crystal polymer members 21 and the isotropic material 24 in the polarizing element 10 according to one embodiment of the present invention is 0.710 μm to 0.716 μm when the height d is 8.9 μm, and the wavelength dependency is also small.

As an example, the polarizing element 10 is used by transmitting light having an optical axis perpendicular to the antireflection film 22B from a negative direction to a positive direction of the Z axis. Note that, the polarizing element 10 may transmit light from the positive direction to the negative direction of the Z axis. Here, with respect to the light transmitted through the polarizing element 10, a region where each of the liquid-crystal polymer members 21 is present is defined as a region A, and a region where each of the liquid-crystal polymer members 21 is not present is defined as a region B. The region A is a region for controlling polarization. Hereinafter, the region for controlling polarization is referred to as a polarization controlled region. The region B is a region where polarization is not controlled. Hereinafter, the region where polarization is not controlled is referred to as a polarization uncontrolled region. In the example shown in FIG. 2, the light transmitted through the region A in the polarizing element 10 sequentially passes through the antireflection film 22B, the deterioration preventing material 23B, each of the liquid-crystal polymer members 21, the isotropic material 24, the deterioration preventing material 23A, and the antireflection film 22A. In the example shown in FIG. 2, the light passing through the region B in the polarizing element 10 sequentially passes through the antireflection film 22B, the deterioration preventing material 23B, the isotropic material 24, the deterioration preventing material 23A, and the antireflection film 22A.

In the polarizing element 10, each of the liquid-crystal polymer members 21 rotates the polarization of the transmitted light. That is, the polarization of the light transmitted through the region A including each of the liquid-crystal polymer members 21 is rotated by 90°. The polarization of the light transmitted through the region B not including each of the liquid-crystal polymer members 21 is not rotated. That is, the light transmitted through the region B has a polarization direction same as that of the incident light.

In the example in FIG. 2, light L1 to be transmitted through the region A has polarization in the Y-axis direction. When the light L1 is transmitted through the region A, the polarization of light L1 is rotate by 90° and the light L1 becomes light polarized in the X-axis direction.

In the example in FIG. 2, light L2 to be transmitted through the region B has polarization in the X-axis direction. The polarization direction of the light L2 does not change even when transmitted through the region B. That is, the light L2 transmitted through the region B is has polarization in the X-axis direction.

When the light in which P-polarized light and S-polarized light are alternately arranged enters the polarizing element 10 such that the P-polarized light enters the region A and the S-polarized light enters the region B, the polarization state of the transmitted light is aligned with the S polarization. When the light in which S-polarized light and P-polarized light are alternately arranged enters the polarizing element 10 such that the S-polarized light enters the region A and the P-polarized light enters the region B, the polarization state of the transmitted light is aligned with the P polarization. In this manner, the polarizing element 10 can align two types of polarization directions different by 90° into one direction. The polarizing element 10 is used after separating light into two beams of linearly polarized light orthogonal to each other by, for example, a polarization separation element, and aligns the two beams of linearly polarized light orthogonal to each other into light polarized in one direction. Here, the linearly polarized light is, for example, P-polarized light and S-polarized light.

The difference in optical distance between the light transmitted through the region A and the light transmitted through the region B is 1 μm or less.

As described above, the following matters are disclosed in the present description.
[1] A polarizing element including:

a first planar member transparent to light;

liquid-crystal polymer members provided on a surface of the first planar member so as to extend in one direction at a regular interval having a predetermined pitch along the surface of the first planar member; and

an isotropic member provided on the surface of the first planar member so as to contain the liquid-crystal polymer members, in which

an aspect ratio is smaller than 1, the aspect ratio being a ratio of a height of each of the liquid-crystal polymer members to ½ times the pitch between two of the liquid-crystal polymer members adjacent to each other.
[2] The polarizing element according to [1], in which

the aspect ratio is 0.2 or less.
[3] The polarizing element according to [1] or [2], in which

the liquid-crystal polymer members and the isotropic member are configured such that a polarization of light passing through each of the liquid-crystal polymer members is rotated by 90 degrees and a polarization of light passing through the isotropic member without passing through each of the liquid-crystal polymer members is not rotated.
[4] The polarizing element according to any one of [1] to [3], in which

each of the liquid-crystal polymer members has a height of 2 μm to 10 μm, and the pitch between two of the liquid-crystal polymer members adjacent to each other is 100 μm to 1000 μm.
[5] The polarizing element according to any one of [1] to [4], in which

each of the liquid-crystal polymer members has the value of the difference Δn between the refractive index with respect to the slow axis and the refractive index with respect to the fast axis of 0.03 to 0.12 at 1550 nm.
[6] The polarizing element according to any one of [1] to [5], in which

each of the liquid-crystal polymer members has the value of the difference Δn between the refractive index with respect to the slow axis and the refractive index with respect to the fast axis of 0.05 to 0.11 at 1550 nm.
[7] The polarizing element according to any one of [1] to [6], in which

a difference in optical distance between light passing through each of the liquid-crystal polymer members and light passing through the isotropic member without passing through each of the liquid-crystal polymer members is 1 μm or less.
[8] The polarizing element according to any one of [1] to [7], further including:

a second planar member that is transparent to light and is provided on a surface of the isotropic member, the surface of the isotropic member being a farther surface from the first planar member;

a first antireflection film that is configured to prevent reflection of light and is provided on a surface of the first planar member, the surface of the first planar member being farther surface from the isotropic member; and

a second antireflection film that is configured to prevent reflection of light and is provided on a surface of the second planar member, the surface of the second planar member being farther surface from the isotropic member.
[9] The polarizing element according to any one of [1] to [8], in which

a wavelength of the light is 1525 nm to 1630 nm.
[10] The polarizing element according to any one of [1] to [9], in which each of the liquid-crystal polymer member is formed of a polymer of a liquid-crystal composition containing a compound represented by the following formula (1),

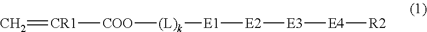

where symbols in the formula represent the following:

R1 is a hydrogen atom or a methyl group,

R2 is an alkyl group having 1 to 8 carbon atoms or a fluorine atom,

k is 0 or 1,

L is —(CH₂)ₚO— or —(CH₂)_{q}—,

provided that p and q are each independently an integer of 2 to 8,

E1 is a 1,4-phenylene group,

E2, E3, and E4 are each independently a 1,4-phenylene group or a trans-1,4-cyclohexylene group, and at least one of E2 or E3 is a trans-1,4-cyclohexylene group, and

in the 1,4-phenylene group and the trans-1,4-cyclohexylene group in E1 to E4, a hydrogen atom bonded to a carbon atom in the group may be substituted with a fluorine atom, a chlorine atom, or a methyl group.
[11] The polarizing element according to any one of [1] to [10], in which

the first planar member and the second planar member are made of quartz.
[12] A wavelength selective switch including:

the polarizing element according to any one of [1] to [11].

### EXAMPLES

Next, Examples of the present invention are described with reference to FIGS. 2 to 5. Note that, the present invention is not limited to these Examples. Example 1 shown below is an Inventive Example, and Examples 2 and 3 shown below are Comparative Examples.

The transmittance was calculated using the ratio of the intensity of the incident light

and the intensity of the transmitted light. The phase step is a difference in optical distance between the light transmitted through the polarization controlled region and the light transmitted through the polarization uncontrolled region. The optical distance is a value obtained by multiplying a refractive index of a medium through which light travels by the distance which light travels. The aspect ratio is an aspect ratio in the structure of the polarization controlled region. The refractive index is a refractive index at a wavelength of 1550 nm.

### Example 1

A polarizing element in Example 1 having a structure same as that of the polarizing element 10 shown in FIG. 1 was formed. An oriented film was formed on the surface of the deterioration preventing material 23B by a rubbing method, and a liquid crystal was injected onto the deterioration preventing material 23B to form a liquid-crystal polymer film. The formed liquid-crystal polymer film was patterned by a photolithography method to form liquid-crystal polymer members 21 each having a height d and arranged at an equal interval having a pitch P, similar to the structure of the polarizing element 10 shown in FIG. 1. After the liquid-crystal polymer members 21 was formed, the isotropic material 24 was used for filling. The deterioration preventing material 23A was formed on the surface of the isotropic material 24, and the surfaces of the deterioration preventing materials 23A and 23B was coated with the antireflection films 22A and 22B. The pitch P of the liquid-crystal polymer members 21 at 1550 nm is 400 μm, and the height d is 8.9 μm. Each of the liquid-crystal polymer members 21 has a refractive index of 1.5257 with respect to the fast axis and a refractive index of 1.6249 with respect to the slow axis. The refractive index of the isotropic material 24 is 1.4951.

With the above, the polarizing element in Example 1 was obtained.

### Example 2

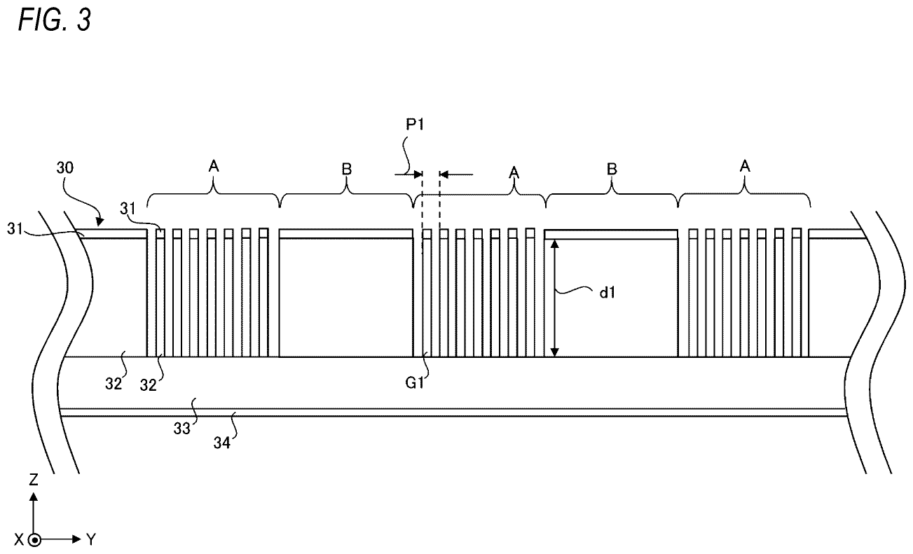

FIG. 3 is a diagram illustrating an example of a first polarizing element for comparison. A polarizing element in Example 2 having a structure same as that of a polarizing element 30 shown in FIG. 3 was formed. A space layer 32 made of Ta₂O₅ was formed on a surface of a substrate 33 made of SiO₂. An index matching layer 31 made of SiO₂ was formed on a surface of the space layer 32. The index matching layer 31 and the space layer 32 in the region A were subjected to grating processing shown in FIG. 3. An antireflection film 34 was vapor-deposited and coated on a surface of the substrate 33 opposite to the surface in contact with the space layer 32. In the polarizing element 30 shown in FIG. 3, the region A is a polarization controlled region, and the region B is a polarization uncontrolled region.

Gratings G1 of the space layer 32 subjected to the grating processing shown in FIG. 3 are arranged at an equal interval having a pitch P1 in the Y-axis direction. The pitch P1 is 0.7 μm. The grating G1 has a height d1 of 1.54 μm. The space layer 32 has a refractive index of 2.089. The index matching layer 31 has a refractive index of 1.451.

With the above, the polarizing element in Example 2 was obtained.

### Example 3

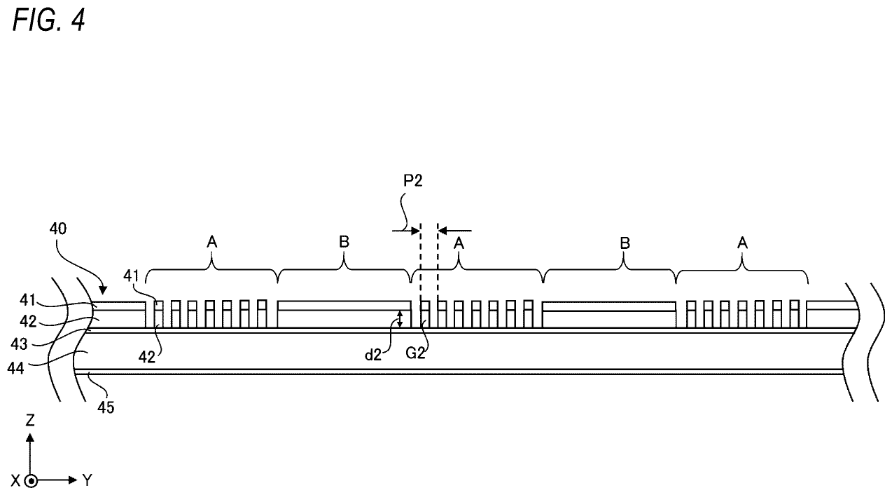

FIG. 4 is a diagram illustrating an example of a second polarizing element for comparison. A polarizing element in Example 3 having a structure same as that of a polarizing element 40 shown in FIG. 4 was formed. An etching stop layer 43 made of Al₂O₃ was formed on a surface of a substrate 44 made of SiO₂. A space layer 42 made of Si was formed on a surface of the etching stop layer 43. An index matching layer 41 made of Ta₂O₅ was formed on a surface of the space layer 42. The space layer 42 and the index matching layer 41 in the region A were subjected to grating processing shown in FIG. 4. An antireflection film 45 was vapor-deposited and coated on a surface of the substrate 44 opposite to the surface in contact with the etching stop layer 43. In the polarizing element 40 shown in FIG. 4, the region A is a polarization controlled region, and the region B is a polarization uncontrolled region.

Gratings G2 of the space layer 42 subjected to the grating processing shown in FIG. 4 are arranged at an equal interval having a pitch P2 in the Y-axis direction. The pitch P2 is 0.7 μm. The grating G2 has a height d2 of 0.49 μm. The index matching layer 41 has a refractive index of 2.089. The space layer 42 has a refractive index of 3.47. The etching stop layer 43 has a refractive index of 1.750.

With the above, the polarizing element in Example 3 was obtained.

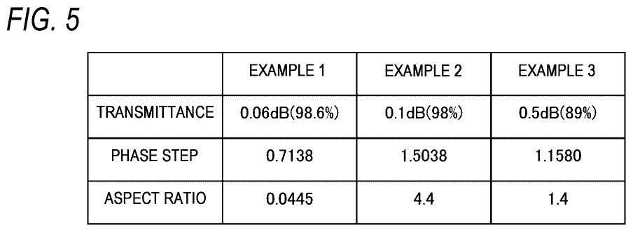

The transmittance, the phase step, and the aspect ratio of each of the polarizing elements are shown in FIG. 5. FIG. 5 is a diagram showing the transmittance, the phase step, and the aspect ratio of the polarizing elements in Examples 1 to 3. The polarizing element in Example 1 has a transmittance of 98.6%, which is higher than the transmittance of the polarizing element in Example 2 and the polarizing element in Example 3. In the polarizing element in Example 1, since each of the liquid-crystal polymer members 21 in the polarization controlled region has a solid structure, a multilayer AR film without an air interface can be formed on the surface of the polarizing element in Example 1. Accordingly, the polarizing element in Example 1 has a high transmittance. Accordingly, the polarizing element in Example 1 is a polarizing element having high transmission performance and high reliability that prevents deterioration of incident light.

The polarizing element in Example 1 has a phase step of 0.7138. The polarizing element in Example 2 has a phase step of 1.5038, and the polarizing element in Example 3 has a phase step of 1.1580. That is, the phase step of the polarizing element in Example 1 is smaller than those of the polarizing element in Example 2 and the polarizing element in Example 3. When the phase step is large, the light transmitted through the polarization controlled region and the light transmitted through the polarization uncontrolled region may have different coupling efficiencies to a fiber, which may result in a decrease in signal level. Therefore, in the polarizing element in Example 1, the coupling efficiencies to the fiber of the light transmitted through the polarization controlled region and the light transmitted through the polarization uncontrolled region can be made equal. In addition, in the case of using the polarizing element in Example 1 in a wavelength selective switch, it is possible to prevent an insertion loss to an element disposed downstream the polarizing element in Example 1 in a light path. The element disposed downstream the polarizing element in Example 1 is, for example, a LCOS.

The polarizing element in Example 1 has an aspect ratio of 0.0445. The polarizing element in Example 2 has an aspect ratio of 4.4, and the polarizing element in Example 3 has an aspect ratio of 1.4. The larger the aspect ratio, the finer the structure, making it more difficult to process. The aspect ratio of the polarizing element in Example 1 is smaller than the aspect ratio of the polarizing element in Example 2 and the aspect ratio of the polarizing element in Example 3. Since the polarizing element in Example 1 can have a small aspect ratio, it is a polarizing element that does not require fine processing.

As described above, the polarizing element in Example 1 can have high

transmissibility, can make the coupling efficiencies to the fiber of the light transmitted through the polarization controlled region and the light transmitted through the polarization uncontrolled region equal, and can also be easy to process.

Although the embodiment has been described above with reference to the accompanying drawings, the present invention is not limited thereto. It will be apparent to those skilled in the art that various modifications, alterations, substitutions, additions, deletions, and equivalents may be made within the scope of the claims, and it will be understood that these also fall within the technical scope of the present invention. Further, the components described in the above embodiment may be combined in any manner without departing from the spirit of the invention.

Note that, the present application is based on a Japanese Patent Application (No. 2023-027569) filed on Feb. 24, 2023, contents of which are incorporated herein by reference.

### INDUSTRIAL APPLICABILITY

The technique in the present invention is useful as a polarizing element that does not require processing of fine irregularities.

### REFERENCE SIGNS LIST

10, 30, 40 polarizing element
21 liquid-crystal polymer members
22, 22A, 22B, 34, 45 antireflection film
23A, 23B deterioration preventing material
24 isotropic material
27 first surface
28 second surface
31, 41 index matching layer
32, 42 space layer
33, 44 substrate
43 etching stop layer
G1, G2 grating
L1, L2 light
P, P1, P2 pitch
d, d1, d2 height

1. A polarizing element comprising:
a first planar member transparent to light;
liquid-crystal polymer members provided on a surface of the first planar member so as to extend in one direction at a regular interval having a predetermined pitch along the surface of the first planar member; and
an isotropic member provided on the surface of the first planar member so as to contain the liquid-crystal polymer members, wherein
an aspect ratio is smaller than 1, the aspect ratio being a ratio of a height of each of the liquid-crystal polymer members to ½ times the pitch between two of the liquid-crystal polymer members adjacent to each other.

2. The polarizing element according to claim 1, wherein
the aspect ratio is 0.2 or less.

3. The polarizing element according to claim 1, wherein
the liquid-crystal polymer members and the isotropic member are configured such that a polarization of light passing through each of the liquid-crystal polymer members is rotated by 90 degrees and a polarization of light passing through the isotropic member without passing through each of the liquid-crystal polymer members is not rotated.

4. The polarizing element according to claim 1, wherein
each of the liquid-crystal polymer members has a height of 2 μm to 10 μm, and the pitch between two of the liquid-crystal polymer members adjacent to each other is 100 μm to 1000 μm.

5. The polarizing element according to claim 1, wherein
each of the liquid-crystal polymer members has a value of a difference Δn between a refractive index with respect to a slow axis and a refractive index with respect to a fast axis of 0.03 to 0.12 at 1550 nm.

6. The polarizing element according to claim 5, wherein
each of the liquid-crystal polymer members has the value of the difference Δn between the refractive index with respect to the slow axis and the refractive index with respect to the fast axis of 0.05 to 0.11 at 1550 nm.

7. The polarizing element according to claim 1, wherein
a difference in optical distance between light passing through each of the liquid-crystal polymer members and light passing through the isotropic member without passing through each of the liquid-crystal polymer members is 1 μm or less.

8. The polarizing element according to claim 1, further comprising:
a second planar member that is transparent to light and is provided on a surface of the isotropic member, the surface of the isotropic member being a farther surface from the first planar member;
a first antireflection film that is configured to prevent reflection of light and is provided on a surface of the first planar member, the surface of the first planar member being farther surface from the isotropic member; and
a second antireflection film that is configured to prevent reflection of light and is provided on a surface of the second planar member, the surface of the second planar member being farther surface from the isotropic member.

9. The polarizing element according to claim 1, wherein
a wavelength of the light is 1525 nm to 1630 nm.

10. The polarizing element according to claim 1, wherein each of the liquid-crystal polymer member is formed of a polymer of a liquid-crystal composition containing a compound represented by the following formula (1), 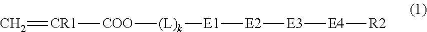
where symbols in the formula represent the following:
R1 is a hydrogen atom or a methyl group,
R2 is an alkyl group having 1 to 8 carbon atoms or a fluorine atom,
k is 0 or 1,
L is —(CH₂)ₚO— or —(CH₂)_{q}—,
provided that p and q are each independently an integer of 2 to 8,
E1 is a 1,4-phenylene group,
E2, E3, and E4 are each independently a 1,4-phenylene group or a trans-1,4-cyclohexylene group, and at least one of E2 or E3 is a trans-1,4-cyclohexylene group, and
in the 1,4-phenylene group and the trans-1,4-cyclohexylene group in E1 to E4, a hydrogen atom bonded to a carbon atom in the group may be substituted with a fluorine atom, a chlorine atom, or a methyl group.

11. The polarizing element according to claim 8, wherein
the first planar member and the second planar member are made of quartz.

12. A wavelength selective switch comprising:
the polarizing element according to claim 1.
